(19) United States
(12) Patent Application Publication
(10) Pub. No.: US 2006/0150728 A1
(43) Pub. Date: Jul. 13, 2006

(54) Submerged current indicator

(76) Inventors: Joseph Puglisi, Port Lincoln (AU); Cameron Giles McDonald, Henley Beach (AU)

Correspondence Address: BIO INTELLECTUAL PROPERTY SERVICES (BIO IPS) LLC, 8509 KERNON CT., LORTON, VA, 22079, US

(21) Appl. No.: 10/567,854

(22) PCT Filed: Aug. 6, 2004
(86) PCT No.: PCT/AU04/01044

§ 371 Date: Apr. 5, 2006

(30) Foreign Application Priority Data
Aug. 11, 2003 (AU) 2003904236

(51) Int. Cl. G01P 13/00

(52) U.S. Cl. 73/170.33

(57) ABSTRACT

An apparatus (10) adapted to indicate the direction of water current at a pre-determined depth of water, including a floating device (20) and a weighted sail member (24) connected (26) thereto. The floating device (20) acting as a visual indicator at the surface to users as to the direction of water current at the depth of the weighted sail member (24), the sail member (24) being of a weight and configuration to drag the floating device (20) without submerging it. A fisherman commencing a berley trail (18) at a particular depth of water can use the apparatus (10) to determine which direction to cast bait.

The present invention relates to a berley trail indication apparatus and, in particular, to a submerged water capturing means in connection with a floating device that is visible to a fisherman for indicating to the fisherman the direction of current at the general depth of the water capturing means.

### BACKGROUND OF THE INVENTION

Creating and maintaining a berley or chum trail is of utmost importance in any form of bait-fishing. The aim of a berley trail is to draw fish from surrounding areas as close as possible to the area in which a fisherman is casting his or her bait. There are generally two types of berley trail, a surface trail which is aimed at luring surface feeding fish and bottom trails aimed at luring bottom feeding fish. The present invention may be used in either situation.

Surface trails are typically achieved by either manually dispensing berley over the side of the boat, or with the use of a berley pot which hangs over the boat slightly submerged which slowly dispenses the berley contained therein through small holes around its side. Bottom trails are usually achieved by using a weighted berley dispensing device that sits 1-2 metres above the sea floor. Although berley trails are known to be effective tools in attracting fish, a known problem exists in that underwater current often pulls the trail in a direction unknown to the fisherman, this being a result of current travelling in different directions at different depths of water beneath. Therefore, the area that is being fished is often not the same area as the area through which the berley trail is moving.

Although there are known methods for measuring the direction of water current, insofar as the applicant is aware there exists no berley trail indication device or apparatus that is easy to use, and which is capable of not only indicating the direction in which a berley trail is moving at the surface, but at any pre-determined depth of water.

It is therefore an object of the present invention to overcome at least some of the aforementioned problems or to provide the public with a useful alternative.

### SUMMARY OF THE INVENTION

Therefore in one form of the invention there is proposed an apparatus for indicating a direction of current at a desired depth in a body of water, said apparatus characterised by:
a floating means adapted to float on a surface of said body of water; and
a water capturing means in connection with said floating means, said water capturing means adapted to be submerged to said desired depth beneath the surface of water for capturing moving water at that depth and thereby moving said floating means in the direction of said moving water.

Preferably the length of said connection between the floating means and water capturing means is adjustable to allow for the capture of water at depths according to said length.

In preference said water capturing means is of a weight heavy enough to remain submerged beneath the surface of water, but light enough such that said floating means connected thereto remains substantially above the surface of water.

In preference said water capturing means is configured such that when a flow of water sweeps past it, it moves into a position where a face of the water capturing means becomes generally perpendicular to the flow of water thereby thrusting said water capturing means in the direction of flow.

Preferably said connection between the water capturing means and floating means is a tethered connection.

Advantageously said tethered connection is a rope.

In preference said face of the water capturing means is positioned at its base, said water capturing means further including a longitudinal portion extending perpendicularly outwardly from said face and guiding said flowing water thereagainst.

Preferably the face of said water capturing means is a substantially square base plate and said longitudinal portion comprises two substantially rectangular plates joined to one another along their central longitudinal axes thereby forming four perpendicularly disposed fins, each of said rectangular plates being aligned along a diagonal axis of said square base plate.

Preferably the face of said water capturing means is a substantially triangular base plate and said longitudinal portion comprises three fins angularly disposed about a central point of said base plate, each of said fins being directed toward each apex of said triangular base member.

Preferably the face of said water capturing means is the inner surface of a conical member including open ends, and said longitudinal portion comprises two plates joined along the central longitudinal axis of the conical member and housed perpendicularly relative to one another within said conical member.

Advantageously said water capturing means is constructed of waterproof material such as aluminium.

Preferably said apparatus is adapted for use from a boat whereby said floating means is secured to said boat in a second tethered connection.

In preference said second tethered connection is in the form of a string such as monofilament fishing line.

In preference said floating means is in the form of a fishing float having a generally conical shape.

In a further form of the invention there is proposed an apparatus for indicating to a person a direction of water current at a desired depth of water, said apparatus characterised by:
a floating indicator that is visible to said person; and
a weighted sail in connection with said floating indicator through a tether of a length corresponding with said desired depth, said sail configured to be moved by the force of the water current in the direction of the water current to thereby also move the floating indicator in the direction of the water current, despite the direction of water current generally above or below said desired depth.

In a still further form of the invention there is proposed a berley trail indication apparatus for indicating to a fisherman a direction in which a berley trail is moving when commenced at a pre-determined depth of water, said berley trail indication apparatus characterised by:
a floating indicator that is visible to the fisherman;
a berley source adapted to be submerged in the water to said pre-determined depth;
a weighted sail in connection with said floating indicator through a tether of a length slightly greater than said pre-determined depth, said weighted sail configured to be moved by the force of the water current in the direction of the water current to thereby also move the floating indicator in the same direction, this indicating to the fisherman the general direction in which the berley trail is moving at that depth.

Advantageously the weighted sail is submerged a depth of approximately 2 metres greater than the depth of the berley source.

### BRIEF DESCRIPTION OF THE DRAWINGS

The accompanying drawings, which are incorporated in and constitute a part of this specification, illustrate several implementations of the invention and, together with the description, serve to explain the advantages and principles of the invention. In the drawings,

FIG. 1 illustrates a schematic perspective view of a berley trail indication apparatus in accordance with the present invention;

FIG. 2 illustrates a top view of the berley trail indication apparatus of FIG. 1 whereby the water current moves toward the rear of the boat and the wind is negligible;

FIG. 3 illustrates a top view of the berley trail indication apparatus of FIG. 1 whereby the water current moves sideways from the boat and the wind is directed toward the rear of the boat;

FIG. 4 illustrates a top view of the berley trail indication apparatus of FIG. 1 whereby the water current moves sideways toward the front of the boat and the wind is directed toward the rear of the boat;

FIG. 5 illustrates a perspective view of the water capturing means forming part of the berley trail indication apparatus of the present invention;

FIG. 6 illustrates a perspective view of a water capturing means in accordance with a second embodiment of the present invention; and

FIG. 7 illustrates a perspective view of a water capturing means in accordance with a third embodiment of the present invention.

### DESCRIPTION OF THE PREFERRED EMBODIMENTS

The following detailed description of the invention refers to the accompanying drawings. Although the description includes exemplary embodiments, other embodiments are possible, and changes may be made to the embodiments described without departing from the spirit and scope of the invention. Wherever possible, the same reference numbers will be used throughout the drawings and the following description to refer to the same and like parts.

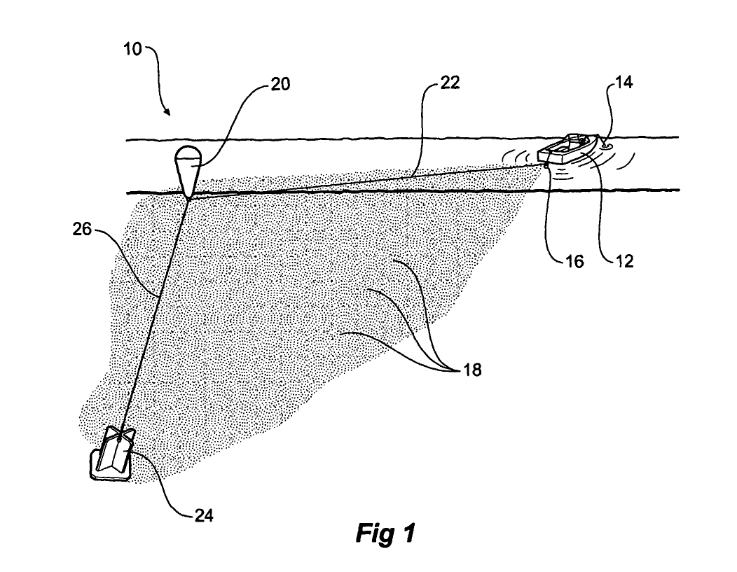

FIG. 1 illustrates a berley trail indication apparatus 10 in accordance with the present invention. There is shown a boat 12 that is anchored 14 and including a berley pot 16 hanging from the side of the boat 12 so that a berley trail 18 is achieved. A floating device or float 20 is connected to the berley pot 16 through fishing line 22. A water capturing means in the form of a sail member or sail 24, connected to the floating device 20 via rope 26 and submerged under its own weight, is of a design which captures flowing water thereby pulling the float 20 in the direction of the current acting on the sail member 24. This action indicates to fishermen (not shown) in the boat 14 the direction in which the current is travelling at the depth of water of the sail member 24, and hence the direction in which the berley trail 18 is travelling. Therefore, the apparatus 12 disclosed in the present invention indicates to fisherman an area of water 28 in which to the cast their bait which corresponds with the same area of water in which the berley is being dispersed. The advantages of being able to position your bait in the path of a berley trail 18 are well known.

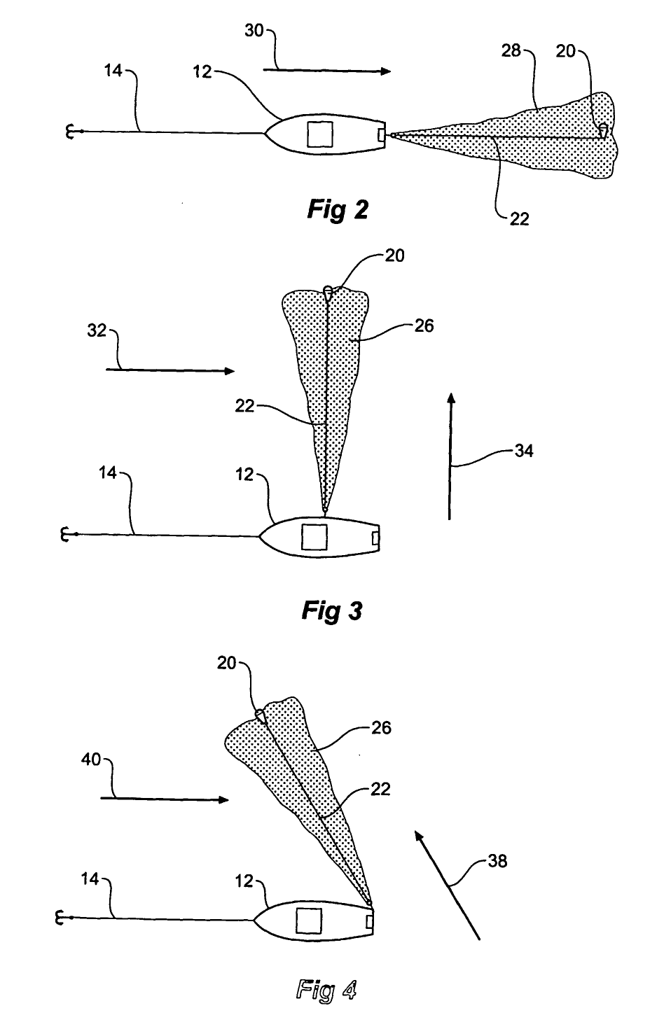

Referring now to FIGS. 2-4, there are shown examples of the direction in which the float 20 is made to travel in various natural situations that may occur at sea, and more particularly, when there is no or very slight wind as in FIG. 2 where the current 30 is moving toward the rear of the boat 12; in FIG. 3 where although there is wind 32 travelling toward the rear of the boat 12, the floating device 20 continues to move with the current 34 directed sideways from the boat 12; and in FIG. 4 where once again although wind 36 is directed toward the rear of the boat 12, the floating device 20 is being pulled in the direction of the current 38 at an angle to the boat that is almost opposing the direction of the wind 40. These are examples of situations in which the direction of the current and hence the direction of the indication apparatus 10 may vary regardless of the surface conditions such as wind and/or surface current. This is an important factor to consider as when fishing at sea, people often mistakenly assume that the berley is being carried in the direction of the wind or current at the surface, when in fact it may be moving in the opposite direction.

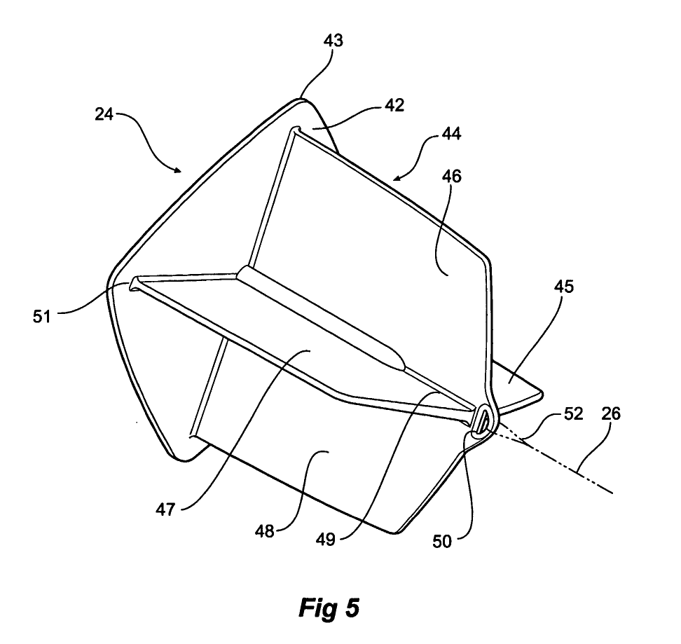

FIG. 5 illustrates a metal sail 24 in accordance with a first embodiment of the present invention. The metal sail 24 includes a substantially square flat base 42 having tapered corners 43, and a projection 44 extending outwardly therefrom, the projection 44 being in the form of four longitudinal plates or fins 45, 46, 47 and 48 which are joined along a central longitudinal axis 49. Alternatively, this structure may be formed by two plates (not shown), one of which includes a longitudinal slit adapted to engage the other plate so that four perpendicularly disposed fins are formed. Each of the perpendicularly crossed fins 45, 46, 47 and 48 of the projection 44 extend outwardly from the longitudinal axis 49 toward individual tapered corners 43. However, the fins 45, 46, 47 and 48 do not span the entire diagonal corner-to-corner distance, but to a point 51 slightly inwards therefrom. This configuration ensures that the sail 24 sufficiently captures a body of water moving there through. The fins 45, 46, 47 and 48 act as guides along which flowing water is drawn so that the water is forced to impact the surface of the base 42 to thereby force the sail 24 in the direction of the current.

The projection 44 further includes an aperture 50 that is located at the upper end of the projection 44. The aperture 50 extends through the part of the projection 44 where the fins 46 and 48 are joined. The rope 26 is adapted to be fastened to the aperture 50 as is shown in FIG. 1. The connection between rope 26 and sail 24 in FIG. 5 may be that of a simple fishing knot 52, but any secure knot will suffice.

Those skilled in the art would realise that when a current sweeps past the sail 24, the sail will rise up due to its structural configuration. However, the sail 24 is of a weight such that it will be maintained submerged substantially at the desired level in the water even when the strongest of currents sweeps past it. The weight is not heavy enough however to submerge the floating device 20. Even if the sail does rise slightly, it will be rising in the direction of the current and thus will still serve to indicate to a person at the surface of the water the direction of current at the desired level.

It is to be understood that the length of rope 26 between float 20 and sail 24 is adjustable. This allows the user to assemble the apparatus 10 of the present invention to suit the environment in which he or she is fishing. For example, if a berley trail 18 is started at a particular depth below the surface of water, the user may simply lower the sail 24 to the same or similar depth so that the floating device 20 still remains visible above the surface thereby indicating the direction of current and hence the direction of the berley trail 18 at that particular depth. This is an especially important consideration as water current in the ocean is known to travel in different directions at different depths. During trials of the apparatus 10, it has been found that in normal conditions where the berley trail 18 is commenced at the surface as shown in FIG. 1, a length of rope 26 of 1.5 metres between the float 20 and sail 24 is sufficient for accurate indication.

In its preferred form, the sail 24 is made of aluminium sheet metal and is of a weight to allow it to sink but not of a weight great enough to submerge the floating device 20 when connected to it. The sail 24 may be constructed of any material suitable for this purpose, metal or non-metal, however, a rustproof material is preferable. All connections between the fins 46 and 48, and the base 42, is preferably achieved through welding. However, any suitable connection means to ensure that the sail 24 does not come apart during a strong water current will suffice.

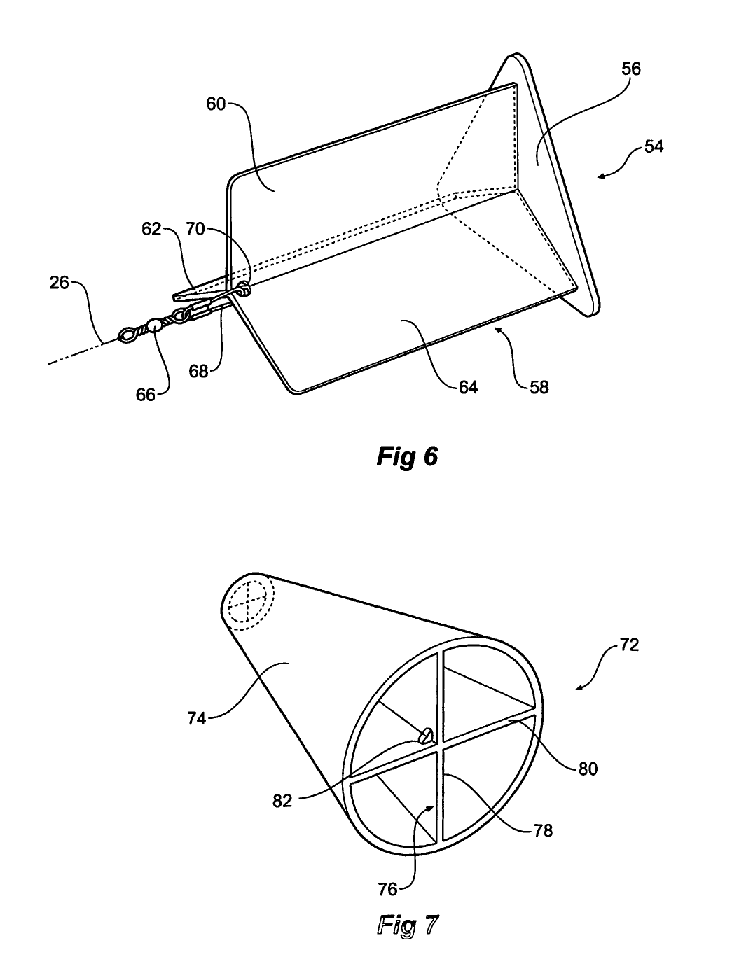

FIGS. 6 and 7 illustrate further embodiments of the present invention, and more specifically, alternate designs of the water capturing means.

FIG. 6 illustrates a sail member 54 including a flat, substantially triangular base 56 having a projection 58 extending outwardly there from, the projection 58 including three angularly disposed fins 60, 62 and 64 aligned with each respective apex of the triangular base 56. The sail 54 of the second embodiment works in substantially the same way as that of the first sail 24 in that flowing water is drawn along the fins 60, 62 and 64 until it impacts the base member 56 thereby forcing the entire sail 54 in the direction of the current. An alternate connection means 66 is also illustrated, namely that of a well known fishing swivel whose metal clip 68 is looped through an aperture 70, again located at an upper portion of the projection 58.

FIG. 7 illustrates a third sail 72 including a substantially conical outer edge 74 that contains an internal frame 76 comprising two perpendicularly crossed fins 78 and 80 for capturing water therein. Neither of the ends of the sail 72 are sealed, so flowing water is able to pass through the sail 72. However, its conical shape provides for a more streamlined surface area to be impacted by the water, thereby achieving a more effective water capturing means. This sail 72 could well be used in calmer conditions where a greater capture of water is required to adequately indicate the direction of the berley trail 18. An aperture 82 is located adjacent the front end of the sail 72 again at the junction between fins 78 and 80 of the frame 76, for connection of a tethering means thereto.

It is to be understood that the shape and configuration of the above water capturing means may well change in accordance with the conditions in which the apparatus 10 is being used. The importance of the water capturing means is to capture water and any shape capable of doing so may be used. In fact, the physical aspects of the other components of the apparatus 10 as represented herein are not intended to be limiting. For example, the floating device 20 as illustrated in FIG. 1 is a substantially conical float designed with a rounded top and lower tapered section adapted to be slightly submerged, this style of float being well known. A floating device that is shaped substantially flat which simply sits on the surface of the water will achieve the same objective.

Furthermore, the present invention is not intended to be limited to the abovementioned tethering means, namely the fishing line 22 between berley pot 16 and floating device 20, and rope 26 between floating device 20 and sail 24. Any tethering means may be used that are capable of supporting the weight of the sail 24 as well as any subsequent force supplied by the strength of the captured current.

It should now be apparent to those skilled in the art that the disclosed invention provides for a means of effectively indicating to fishermen the direction in which a berley trail 18 is moving, this being achieved through the use of a submerged sail 24 that is pulled in the direction of a moving current at a predetermined depth, and in the process moving a floating device 20 that acts as a visual indicator to a fisherman. The depth of the sail 24 is adjustable to suit the depth at which the berley 18 is being dispensed. The apparatus therefore provides fishermen with an indication of an area of water in which to cast their baits which corresponds with the area of water through which the berley trail 18 is moving regardless of surface conditions such as wind or conditions substantially above or below the sail depth.

Further advantages and improvements may very well be made to the present invention without deviating from its scope. Although the invention has been shown and described in what is conceived to be the most practical and preferred embodiment, it is recognized that departures may be made therefrom within the scope and spirit of the invention, which is not to be limited to the details disclosed herein but is to be accorded the full scope of the claims so as to embrace any and all equivalent devices and apparatus.

In any claims that follow and in the summary of the invention, except where the context requires otherwise due to express language or necessary implication, the word “comprising” is used in the sense of “including”, i.e. the features specified may be associated with further features in various embodiments of the invention.

1. An apparatus for indicating a direction of current at a desired depth in a body of water, said apparatus characterized by: a floating means adapted to float on a surface of said body of water; and a water capturing means in connection with said floating means, said water capturing means adapted to be submerged to said desired depth beneath the surface of water for capturing moving water at that depth and thereby moving said floating means in the direction of said moving water.

2. An apparatus as in claim 1 wherein the length of said connection between the floating means and water capturing means is adjustable to allow for the capture of water at depths according to said length.

3. An apparatus as in claim 1 wherein said water capturing means is of a weight heavy enough to remain submerged beneath the surface of water, but light enough such that said floating means connected thereto remains substantially above the surface of water.

4. An apparatus as in claim 3 wherein said water capturing means is configured such that when a flow of water sweeps past it, it moves into a position where a face of the water capturing means becomes generally perpendicular to the flow of water thereby thrusting said water capturing means in the direction of flow.

5. An apparatus as in claim 1 wherein said connection between the water capturing means and floating means is a tethered connection.

6. An apparatus as in claim 5 wherein said tethered connection is a rope.

7. An apparatus as in claim 1 wherein said face of the water capturing means is positioned at its base, said water capturing means further including a longitudinal portion extending perpendicularly outwardly from said face and guiding said flowing water thereagainst.

8. An apparatus as in claim 7 wherein the face of said water capturing means is a substantially square base plate and said longitudinal portion comprises two substantially rectangular plates joined to one another along their central longitudinal axes thereby forming four perpendicularly disposed fins, each of said rectangular plates being aligned along a diagonal axis of said square base plate.

9. An apparatus as in claim 7 wherein the face of said water capturing means is a substantially triangular base plate and said longitudinal portion comprises three fins angularly disposed about a central point of said base plate, each of said fins being directed toward each apex of said triangular base member.

10. An apparatus as in claim 7 wherein the face of said water capturing means is the inner surface of a conical member including open ends, and said longitudinal portion comprises two plates joined along the central longitudinal axis of the conical member and housed perpendicularly relative to one another within said conical member.

11. An apparatus as in claim 1 wherein said water capturing means is constructed of waterproof material such as aluminium.

12. An apparatus as in claim 1 wherein said apparatus is adapted for use from a boat whereby said floating means is secured to said boat in a second tethered connection.

13. An apparatus as in claim 12 wherein said second tethered connection is in the form of a string such as monofilament fishing line.

14. An apparatus as in claim 1 wherein said floating means is in the form of a fishing float having a generally conical shape.

15. An apparatus for indicating to a person a direction of water current at a desired depth of water, said apparatus characterised by: a floating indicator that is visible to said person; and a weighted sail in connection with said floating indicator through a tether of a length corresponding with said desired depth, said sail configured to be moved by the force of the water current in the direction of the water current to thereby also move the floating indicator in the direction of the water current, despite the direction of water current generally above or below said desired depth.

16. A berley trail indication apparatus for indicating to a fisherman a direction in which a berley trail is moving when commenced at a pre-determined depth of water, said berley trail indication apparatus characterized by: a floating indicator that is visible to the fisherman; a berley source adapted to be submerged in the water to the pre-determined depth; a weighted sail in connection with said floating indicator through a tether of a length slightly greater than said pre-determined depth, said weighted sail configured to be moved by the force of the water current in the direction of the water current to thereby also move the floating indicator in the same direction, this indicating to the fisherman the general direction in which the berley trail is moving at that depth.

17. A berley trail indication apparatus as in claim 16 wherein the weighted sail is submerged a depth of approximately 2 metres greater than the depth of the berley source.
